(19) United States
(12) Patent Application Publication
(10) Pub. No.: US 2017/0118620 A1
(43) Pub. Date: Apr. 27, 2017

(54) METHODS AND NODES FOR MANAGING SENSOR VALUES

(71) Applicant: TELEFONAKTIEBOLAGET LM ERICSSON (PUBL), Stockholom (SE)

(72) Inventors: Cristian NORLIN, Stockholm (SE); Marcus GÅRDMAN, Skärholmen (SE); Joakim FORMO, Åkersberga (SE); Anna VIGGEDAL, Stockholm (SE)

(21) Appl. No.: 15/129,358

(22) PCT Filed: Mar. 27, 2014
(86) PCT No.: PCT/SE2014/050371

§ 371 Date: Sep. 26, 2016

(51) Int. Cl. H04W 8/00; H04L 29/08; H04W 28/02; H04W 4/00

(52) U.S. Cl. CPC H04W 8/005; H04W 4/005; H04L 67/12; H04W 28/02; H04W 84/18

(57) ABSTRACT

Methods, a network node and a second device for managing values of a physical quantity are disclosed. The second device is associated with a second receiver device. The network node receives, from the first wireless device, a first value, obtained by a first sensor associated with the first wireless device. The network node receives first and second information about mobility from the first wireless device and the second device, respectively. The network node determines a surrogate value based on at least the first value, when the first information and the second information are within a range for considering the first and second information to be equivalent. The network node sends the surrogate value to the second receiver device.

### TECHNICAL FIELD

Embodiments herein relate to wireless communication systems, such as telecommunication systems. A method and a network node for managing a set of values of a physical quantity as well as a method and a second device for managing sending of a second value of a physical quantity are disclosed. Moreover, corresponding computer programs and carriers for computer programs are disclosed.

### BACKGROUND

In a so called network society virtually every piece of equipment, such as vehicles, fridges, coffeemakers, temperature sensors, mobile phones, heating systems for buildings, traffic systems, etc., will be connected to a network, which may include a telecommunication network. This implies that any increase in efficiency in communication between the pieces of equipment is advantageous, since it is expected that amount of traffic to be handled in the network will be higher than amount of traffic in present networks.

A fifth generation (5G) of networks is therefore developed and proposed to include a number of new characteristics that enables improved efficiency in a variety of different manners. The new characteristics include new structures of network communication, such as device-to-device (D2D) and machine-to-machine (M2M) communication, peer-to-peer (P2P), Wireless Fidelity (W-Fi) network, multi-hop, mobile ad-hoc networks, and more.

In an example relating to the network society, a wireless communication system includes a plurality of connected vehicles. In other examples, the vehicle may be replaced by any piece of equipment as mentioned above or similar equipment. The connected vehicles are remotely controlled by so called remote drivers, which may be computers, control systems, etc. as well as humans. Moreover, the vehicles include a great numbers of sensors. The sensors may be included in the vehicles or connected thereto by means of a wireless communication technology. When the vehicles are connected to each other in P2P networks, such as wireless ad-hoc networks, the great number of sensors may cause problems, such as congestion, delay and/or interruption, in the network due a massive amount of traffic from these sensors. A disadvantage in some cases may hence be that the sensors cause a lot of traffic which may be difficult to handle.

Furthermore, a first vehicle may be operated less beneficial than a second vehicle e.g. with respect to different aspects, such as security, power consumption, safety of the first vehicle.

The less beneficial operation of the first vehicle may be caused by that the first vehicle lacks a first sensor which enables more beneficial operation. In contrast to the first vehicle, the second vehicle includes a sensor which enables such more beneficial operation with respect to at least one of the aforementioned aspects. A problem may hence be how to improve operation of the first vehicle.

In the scenario described above, connected and remotely controlled vehicles are taken as an example. In other examples, the same or similar scenario may be described with reference to all sorts of connected things featuring sensors, where the connected things do not have fixed positions.

### SUMMARY

An object is to improve performance, e.g. in terms of consumed bandwidth, accuracy of information of values relating to physical quantities, what information is available, of a wireless communication system.

According to a first aspect, the object is achieved by a method, performed by a network node, for managing a set of values of a physical quantity. A communication network comprises the network node, a first wireless device and a second device. The first wireless device is associated with a first sensor. The first sensor is capable of detecting the physical quantity to obtain a first value for sending to a first receiver device. The first value is included in the set of values. The second device is associated with a second receiver device. The network node receives, from the first wireless device, the first value of the physical quantity. The first value has been detected by the first sensor. The network node receives first information about mobility from the first wireless device and second information about mobility from the second device. The network node determines a surrogate value based on at least the first value, when the first information about mobility for the first wireless device and the second information about mobility for the second device are within a range for considering the first and second information about mobility to be equivalent. Furthermore, the network node sends the surrogate value to the second receiver device.

According to a second aspect, the object is achieved by a method, performed by a second device, for managing sending of a second value of a physical quantity in order to reduce required bandwidth of a connection for sending of the second value to a network node while maintaining accuracy of the second value above a threshold value. The required bandwidth relates to bandwidth required for the sending of the second value. The second device is associated with a second sensor. The second sensor is capable of detecting the physical quantity to obtain the second value, wherein a first wireless device and the second device are comprised in an ad-hoc network. The ad-hoc network and the network node are comprised in a communication network. The first wireless device is associated with a first sensor capable of detecting the physical quantity to obtain a first value. The first and second devices are connected to the network node in order to enable sharing of a set of values. The set of values includes the first and second values. The second device sends, over the connection to the network node, the second value relating to the physical quantity. The second value has been detected by the second sensor, whereby the network node is able to determine whether a difference between the first and second values is below the threshold value. The second device receives, from the network node, a message instructing the second device to cease to perform the sending of the second value, when the network node has determined that the difference is below the threshold value. Furthermore, the second device ceases to send the second value to the network node.

According to a third aspect, the object is achieved by a network node configured to manage a set of values of a physical quantity. A communication network comprises the network node, a first wireless device and a second device. The first wireless device is associated with a first sensor. The first sensor is capable of detecting the physical quantity to obtain a first value for sending to a first receiver device. The first value is included in the set of values. The second device is associated with a second receiver device. The network node is configured to receive, from the first wireless device, the first value of the physical quantity. The first value has been detected by the first sensor. Furthermore, the network node is configured to receive first information about mobility from the first wireless device, and to receive second information about mobility from the second device. The network node is further configured to determine a surrogate value based on at least the first value, when the first information about mobility for the first wireless device and the second information about mobility for the second device are within a range for considering the first and second information about mobility to be equivalent. Moreover, the network node is configured to send the surrogate value to the second receiver device.

According to a fourth aspect, the object is achieved by a second device configured to manage sending of a second value of a physical quantity in order to reduce required bandwidth of a connection for sending of the second value to a network node while maintaining accuracy of the second value above a threshold value. The required bandwidth relates to bandwidth required for the sending of the second value. The second device is associated with a second sensor. The second sensor is capable of detecting the physical quantity to obtain the second value. A first wireless device and the second device are comprised in an ad-hoc network. The ad-hoc network and the network node are comprised in a communication network. The first wireless device is associated with a first sensor capable of detecting the physical quantity to obtain a first value. The first and second devices are connected to the network node in order to enable sharing of a set of values. The set of values includes the first and second values. The second device is configured to send, over the connection to the network node, the second value relating to the physical quantity. The second value has been detected by the second sensor, whereby the network node is able to determine whether a difference between the first and second values is below the threshold value. The second device is further configured to receive, from the network node, a message instructing the second device to cease to perform the sending of the second value, when the network node has determined that the difference is below the threshold value. Furthermore, the second device is configured to cease to send the second value to the network node.

According to further aspects, the object is achieved by computer programs and carriers for computer programs, which correspond to the aspects above.

The present disclosure includes some first embodiments, some second embodiments and some third embodiments.

The first embodiments are directed towards improving operation in terms of reducing consumed bandwidth. In the example above in the background section, at least some of the great number of sensors, included in the vehicles, is likely to be more or less identical. Hence, one or more sensors may be considered to be redundant.

Therefore, according to the first embodiments, the network node receives, from the second device, a second value of the physical quantity. The second device is associated with a second sensor capable of detecting the physical quantity. The second value has been detected by the second sensor. Moreover, the network node sets the surrogate value to the first value with or without conversion from the first value to the second value, when the first and second values are within a margin for using the first value as basis for the surrogate value to be sent to the second receiver device. Then, the network node sends, to the second device, a message instructing the second device to cease to send the second value, which in view of the margin above is considered to be redundant.

Consequently, since the second device ceases to send the second value, the consumed bandwidth is reduced. Thus, the above mentioned object is achieved.

Moreover, an advantage may be that power consumption of the second device is reduced due to that the second device may cease to send the second value as instructed by the message.

The second embodiments are directed towards improving performance in terms of accuracy of information of values relating to quantities.

Therefore, according to the second embodiments, the network node receives, from the second device, a second value of the physical quantity. The second device is associated with a second sensor capable of detecting the physical quantity. The second value has been detected by the second sensor. Moreover, the network node calculates the surrogate value as an average of the first and second values.

Typically, average values are considered more accurate due to e.g. less fluctuation. As a result, the above mentioned object is achieved.

The third embodiments are directed towards improving performance in terms of what information is available e.g. to the second receiver device. It has been observed that the type of sensors and number of sensor may vary among the devices in the ad-hoc network. It has thus been realized that a device that lacks one type of sensor may receive the same or similar sensor data, i.e. the first and/or second values of the physical quantity, from another device that can provide sensor data from a sensor of that type.

Therefore, the network node receives, from the second receiver device, a request for a requested value, which relates to a requested physical quantity. The second device is incapable of detecting the requested physical quantity to obtain the requested value. Moreover, the network node sets the surrogate value to the first value with or without conversion from the first value to the requested value, when the physical quantity of the first value is equivalent to the requested physical quantity. Thereby, the requested value may be provided to the second receiver device and the above mentioned object is achieved.

It shall here be noted that the embodiments herein may be applied to several scenarios, including the aforementioned vehicles, but also to wireless devices and sensors carried by humans or in other devices moving around in, for example, the city, sensors on for example ships and other objects in the water monitoring different aspects of the water such as temperature, pH, number of fishers passing by, existence of chemicals, gas concentrations and so on. Such sensors can be mobile as well as having fixed locations. For example, at a metro station, on the bus or in any crowd, there will probably be a large number of sensors of the same type reporting similar values due to their coinciding locations, and those could rather be shared. E.g. only a couple of few of them vigilant, and the rest set to a dormant state.

Other exemplifying scenarios include construction site contexts, forestry, or similar, where there are machines equipped with a large amount of sensors operating and executing on certain tasks, which may be remotely controlled.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 is a schematic overview of an exemplifying wireless communication system in which embodiments herein may be implemented,

FIG. 2 is a schematic, combined signaling scheme and flowchart illustrating embodiments of the methods when performed in the wireless communication system according to FIG. 1,

FIG. 3 is a schematic overview of a plurality of remote drivers and a platoon of vehicles,

FIG. 4 is schematic overview of a vehicle, cloud network and a remote driver,

FIG. 5 is a flowchart illustrating embodiments of the method in the network node,

FIG. 6 is a block diagram illustrating embodiments of the network node.

FIG. 7 is a flowchart illustrating embodiments of the method in the second device, and

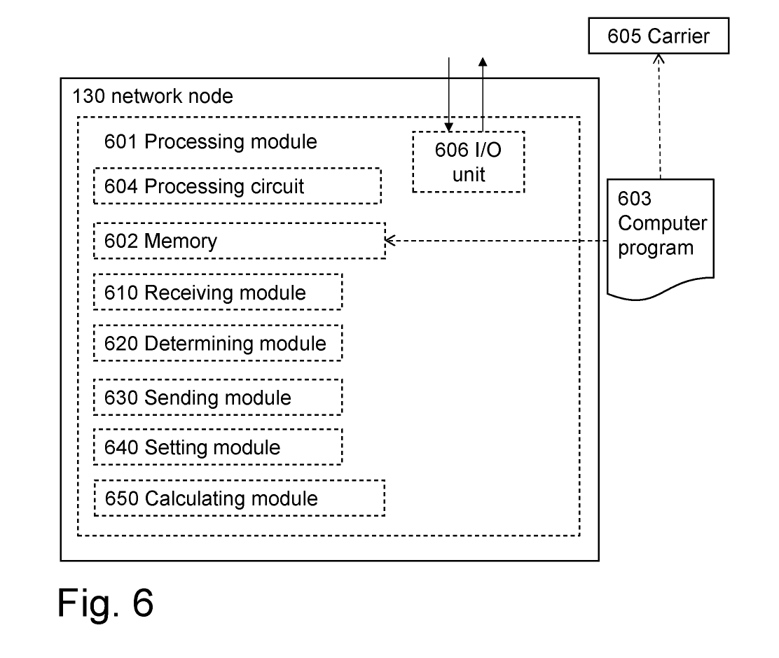

FIG. 6 is a block diagram illustrating embodiments of the second device.

### DETAILED DESCRIPTION

Throughout the following description similar reference numerals have been used to denote similar elements, units, modules, circuits, nodes, parts, items or features, when applicable. In the Figures, features that appear in some embodiments are indicated by dashed lines.

In the initially mentioned network society with significantly increased number of connected and sensor equipped objects, sharing of resources will be a major advantage since resources may thus be saved. Sharing of resources refers to sharing of network resources, such as time and/or frequency, bandwidth, data rate and the like used for transmissions between the connected objects.

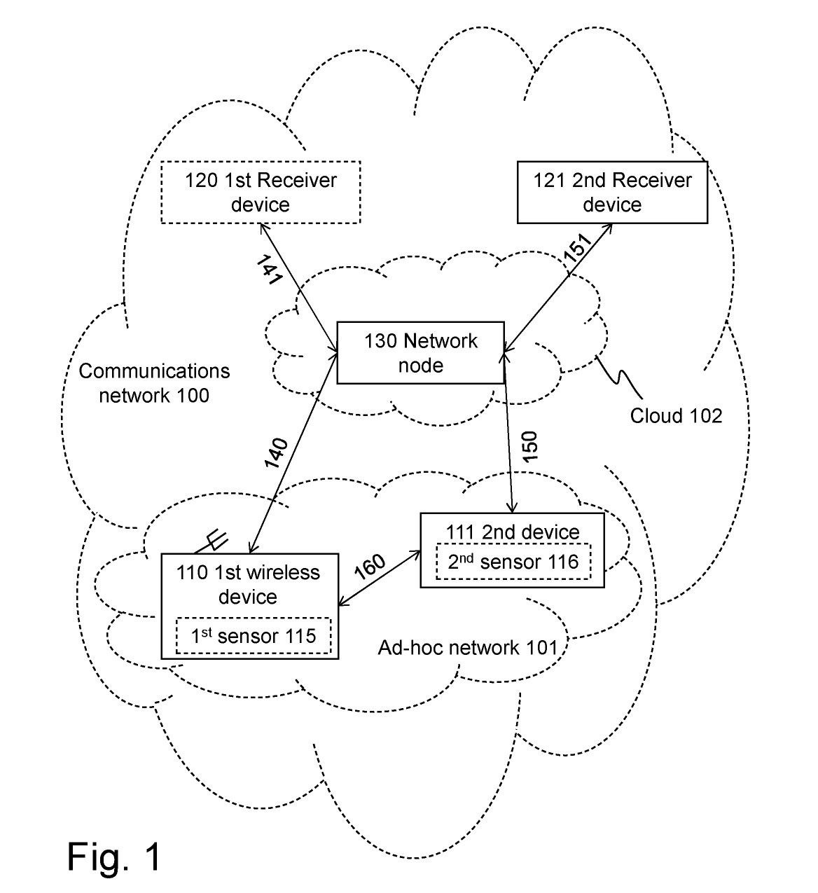

FIG. 1 depicts an exemplifying communications network 100 in which embodiments herein may be implemented. In this example, the communications network 100 includes a wireless network, such as a Long Term Evolution (LTE) system or an evolution thereof. In other examples, the wireless network may be any radio network, such as any 3GPP cellular communication system, such as a 5G network, a Wideband Code Division Multiple Access (WCDMA) network, a Global System for Mobile communication (GSM network) or the like.

The communication network 100 comprises a first wireless device 110, a first receiver device 120 as well as a network node 130. The first wireless device 110 may communicate 140, 141 with the first receiver device 120 via the network node 130, which may be located in a cloud 102.

The first wireless device 110 may be associated with a first sensor 115. This means that the first wireless device 110 may be connected, by wire or wirelessly, to the first sensor 115. Moreover, the first wireless device 110 may comprise the first sensor 115, i.e. the first sensor 115 is internal to the first wireless device 110. Alternatively, the first sensor 115 may be external to the first wireless device 110.

Furthermore, the communication network 100 comprises a second device 111 and a second receiver device 121. The second device 111 may communicate 150, 151 with the second receiver device 121 via the network node 130.

The second device 111 may be associated with a second sensor 116. Again, this means that the second device 111 may be connected, by wire or wirelessly, to the second sensor 116. Moreover, the second device 111 may comprise the second sensor 116, i.e. the second sensor 116 is internal to the second device 111. Alternatively, the second sensor 116 may be external to the second device 111.

The term “receiver device”, such as the first and/or second receiver device 120, 121, may refer to a server, a computer, or the like.

The first wireless device 110 and the second device 111 may form an ad-hoc network 101, such as a wireless ad-hoc network. This means that the first wireless device 110 may communicate 160 directly with the second device 111.

As used herein, the term “wireless device”, such as the first wireless device 110, may refer to a user equipment, a mobile phone, a cellular phone, a Personal Digital Assistant (PDA) equipped with radio communication capabilities, a smartphone, a laptop or personal computer (PC) equipped with an internal or external mobile broadband modem, a tablet PC with radio communication capabilities, a portable electronic radio communication device, a sensor device equipped with radio communication capabilities, a vehicle or the like. The sensor may be any kind of weather sensor, such as wind, temperature, air pressure, humidity etc. As further examples, the sensor may be a light sensor, an electronic switch, a microphone, a loudspeaker, a camera sensor etc.

In this context, it deserves to be mentioned that the term “device”, such as the second device 111, may refer to any electrical device with wired or wireless communication capabilities. Thus, in some examples, the second device 111 is a second wireless device.

As used herein, the term “resource”, or “network resource”, may refer to a certain coding of a signal and/or a time frame and/or a frequency range in which the signal is transmitted. In some examples, a resource may refer to one or more Physical Resource Blocks (PRB) which are used when transmitting the signal. In more detail, a PRB may be in the form of Orthogonal Frequency Division Multiplexing (OFDM) PHY resource blocks (PRB). The term “physical resource block” is known from 3GPP terminology relating to e.g. Long Term Evolution Systems.

Throughout the description of the embodiments herein, vehicles may be referred to as a non-limiting example of a connected object, such as the first wireless device 110 and/or the second device 111.

When vehicles connected over 5G, especially remotely controlled or self-driving, or so called autonomous driving, travel in a line after each other with uniform speed and distance in between, many of their sensors will report more or less identical data. Therefore, if the vehicles and their sensors form a mobile ad-hoc mesh network, including the sensors in the nearest vehicles in back and front, network capacity can be saved if sensors in the mid vehicles enter a dormant state. In such line of vehicles, only the front and rear vehicles have to be in a fully active state, and the vehicles in the middle can be partly controlled via the front and rear vehicles. I.e. connected vehicles can share sensors if connecting to other vehicles in the proximity with sensors reporting identical data and travelling along the same route with the same speed. This redundancy of active sensors is identified and determined by a matching algorithm in the network node 130, such as a cloud component, cloud node, cloud function or the like.

Concerning remotely controlled vehicles, driven by a remote driver over 5G streamed real time high definition 360 degrees video, the first vehicle in the line of vehicles forming the ad-hoc network, can also take over the control of the other vehicles like the engine of a train under certain conditions, like when driving patterns for the vehicles in the line are uniform.

Elaborating further on the example with the connected vehicles, a P2P network, including a set of vehicles, is expected to be formed in dense traffic, such as on highways, where vehicles move with relatively fixed distances in between them and with relatively uniform velocity. Some of the sensors of the vehicles will report more or less identical data. The data can be reported simultaneously or with a slight delay in time as the vehicles do not pass the same coordinate at the very same time instant. When vehicles form such continuous lines, or queues, at the road, aka a platoon, it can be considered superfluous to have all sensors in each and every vehicle in an active state—both in terms of them continuously registering the same data, but also if they continuously transmit this data over a radio network, such as parts of the communication system 100.

Furthermore, a first vehicle may lack a sensor of a certain type, which if available to the first vehicle would be beneficial for the operation of the first vehicle in view of security, power consumption, safety of the first vehicle or the like. Thanks to the great amount of sensors, it is expected that the lacking sensor will be included in a second vehicle, comprised in the P2P network.

The embodiments herein suggest multiple ways of sharing sensors, or in fact sensor data, in local ad-hoc networks, such as P2P networks. With increased density of sensor equipped connected objects, a likelihood of that there exist several sensors, which monitors the same thing and reports equivalent values, is high, e.g. close to one or above a threshold of e.g. 0.7.

In such cases there are gains in network capacity if redundant sensors are put in a dormant state, while data from the sensor(s) that remain vigilant is shared over peer-to-peer links between the sensor equipped objects.

For e.g. cost reasons all objects cannot feature all types of sensors that possibly could be beneficial, why not enable an object to automatically share sensor data with another object in the vicinity that is lacking that particular type of sensor.

This is especially true considering the savings that can be made in terms of processing and power consumption if some sensors can be idle in some circumstances. The same reasoning applies to the associated network traffic. If some sensor data can avoid being sent (since other sensors have catered for the same data), there is a great potential in reducing the load on the radio networks providing the connectivity.

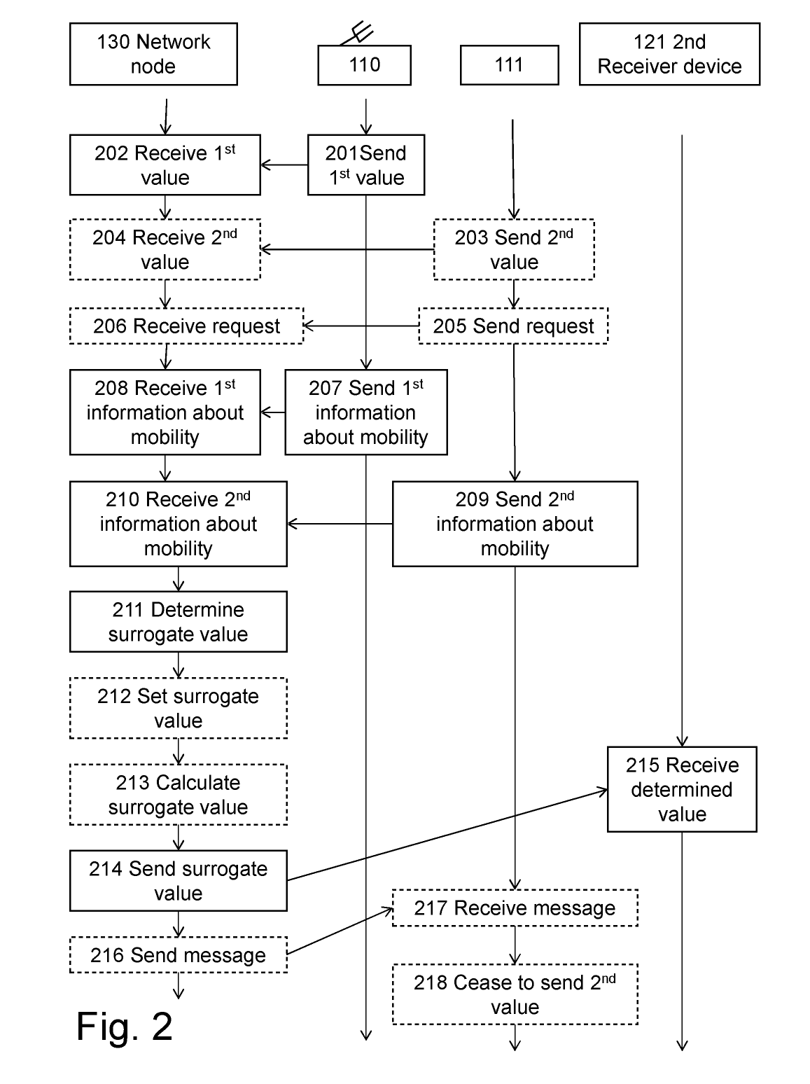

FIG. 2 illustrates exemplifying methods when implemented in the communication network 100 of FIG. 1. Thus, the network node 130 performs a method for managing a set of values of a physical quantity. The second device 111 performs a method for managing sending of a second value of a physical quantity in order to reduce required bandwidth of a connection for sending of the second value to a network node 130 while maintaining accuracy of the second value above a threshold value, which will be described in more detail below. Expressed differently, the second device 111 performs a method for provisioning, to the second receiver device 121, a surrogate value in order to reduce required bandwidth of the connection for sending of the second value while maintaining accuracy of the surrogate value is above the threshold value.

The connection between the network node 130 and the second device 111 is at least partially using the wireless network mentioned in connection with FIG. 1.

As mentioned, the communication network 100 comprises the network node 130, a first wireless device 110 and a second device 111. The first wireless device 110 is associated with the first sensor 115. The first sensor 115 is capable of detecting the physical quantity to obtain a first value for sending to a first receiver device 120. The first value is included in the set of values. The second device 111 is associated with a second receiver device 121.

The required bandwidth relates to bandwidth required for the sending of the second value. As mentioned, the second device 111 is associated with the second sensor 116. The second sensor 116 is capable of detecting the physical quantity to obtain the second value. In some examples, the first wireless device 110 and the second device 111 are comprised in the ad-hoc network 101. The ad-hoc network 101 and the network node 130 are comprised in a communication network 100. As mentioned, the first wireless device 110 is associated with the first sensor 115 capable of detecting the physical quantity to obtain a first value. The first and second devices 110, 111 are connected to the network node 130 in order to enable sharing of a set of values. The set of values includes the first and second values.

Initially, in the first and second embodiments, the network node 130 may have been activated by at least one of the first wireless device 110 and the second device 111 when the at least one of the first wireless device 110 and the second device 111 has detected that the first sensor 115 and the second sensor 116 are capable of sending values relating to the physical quantity, i.e. the same or equivalent physical quantity.

The following actions may be performed in any suitable order.

### Action 201

In order to make it possible for the network node 130 to send, or forward with or without additional processing as described below e.g. in action 211 to 213, the first value of the physical quantity to the first receiver device 120, the first wireless device 110 sends, e.g. at least partly over the wireless network, the first value to the network node 130. The first value has been detected by the first sensor 115.

### Action 202

When action 201 has been performed, the network node 130 receives, from the first wireless device 110, the first value of the physical quantity.

### Action 203

According to the first embodiments, the second device 111 sends, over the connection to the network node 130, the second value relating to the physical quantity. The second value has been detected by the second sensor 116, whereby the network node 130 is able to determine whether a difference between the first and second values is below the threshold value. The threshold value may indicate when to consider the first and second values to be equivalent. The threshold value may be predefined and stored in the network node 130.

In some examples, the first and second values are binary values, e.g. movement or no movement as for a motion sensor. In such example, a threshold may not be required; e.g. either the sensors report yes or they report no. Thus, if identical values then the values are equivalent, otherwise the values are not equivalent.

### Action 204

Also, according to the first embodiments, the network node 130 may receive, from the second device 111, a second value of the physical quantity. The second device 111 is associated with a second sensor 116 capable of detecting the physical quantity, i.e. the same or equivalent physical quantity as detectable by the first sensor 115. The second sensor 116 may thus obtain the second value of the physical quantity. The second value has been detected by the second sensor 116.

### Action 205

According to the third embodiments, the second device 111 may send a request for a requested value, which relates to a requested physical quantity. The second device 111 is incapable of detecting the requested physical quantity to obtain the requested value.

### Action 206

When action 205 has been performed according to the third embodiments, the network node 130 may receive, from the second receiver device 121, the request for the requested value, which relates to the requested physical quantity.

### Action 207

In order to make the network node 130 aware of mobility of the first wireless device 110, the first wireless device 110 sends first information about mobility to the network node 130.

The first information about mobility may refer to velocity of the first wireless device 110, position of the first wireless device 110, direction of movement of the first wireless device 110 and the like.

### Action 208

When action 207 has been performed, the network node 130 receives the first information about mobility from the first wireless device 110.

### Action 209

Similarly to action 207, in order to make the network node 130 aware of mobility of the second device 111, the second device 111 sends second information about mobility to the network node 130.

Again, the second information about mobility may refer to velocity of the first wireless device 110, position of the second device 111, direction of movement of the first wireless device 110 and the like.

### Action 210

When action 209 has been performed, the network node 130 receives the second information about mobility from the second device 111.

### Action 211

When the first information about mobility for the first wireless device 110 and the second information about mobility for the second device 111 are within a range for considering the first and second information about mobility to be equivalent, the network node 130 determines a surrogate value based on at least the first value.

### Action 212

According to the first embodiments, the network node 130 may set the surrogate value to the first value with or without conversion from the first value to the second value, when the first and second values are within a margin for using the first value as basis for the surrogate value to be sent to the second receiver device 121. As an example, the margin may be determined by comparing the difference between the first and second values to the threshold value.

Alternatively or additionally, the network node 130 may, according to the third embodiments, set the surrogate value to the first value with or without conversion from the first value to the requested value, when the physical quantity of the first value is equivalent to the requested physical quantity.

### Action 213

According to the second embodiments, the network node 130 may calculate the surrogate value as an average of the first and second values.

### Action 214

Now that the network node 130 may have processed the first and/or second values in one or more of actions 211-213, the network node 130 sends the surrogate value to the second receiver device 120.

### Action 215

When action 214 has been performed, the second receiver device 120 receives the surrogate value from the network node 130.

### Action 216

Subsequent to action 212 according to the first embodiments, the network node 130 may send, to the second device 111, a message instructing the second device 111 to cease to send the second value. Hence, this action is performed when the network node 130 may have determined that the difference is below the threshold value.

### Action 217

After action 216, the second device 111 consequently receives, from the network node 130, the message instructing the second device 111 to cease to perform the sending of the second value.

### Action 218

Subsequent to action 217 according to the first embodiments, the second device 111 may cease to send the second value to the network node 130. In this manner, the required bandwidth is reduced. This means for example that the second device 111 may set the sensor module 116 in a dormant state, i.e. in an in-active state in which no sensor data is sent, internally or externally, from the sensor module 116 to the second device 111.

In the following a few examples relating to the embodiments herein are presented.

According to the first embodiments, the network node 130, such as a cloud application or cloud component, determines if a sensor can enter a dormant state and instead utilize nearby sensors of the same type that are reporting equivalent values—that is, share sensors. If so, the redundant sensor can go to sleep and the equivalent sensor in the proximity reroutes the data stream to the receiver of the now sleeping sensor's data too.

In order to improve network capacity it can be beneficial to let certain sensors in e.g. a vehicle in the middle of a line or all but the first vehicles equivalent sensors, to enter a dormant state.

One simple example apart from the remotely controlled vehicle case is two persons that are at the same location, both having connected devices measuring for example temperature. If both sensors are reporting the same values, one of the sensors can enter a dormant state and the other report values for both devices. The sensors are connected in a mobile ad-hoc mesh network (MANET). In this example, the sensors have to report the same value, because matching location is not enough, i.e. one of them can be measuring temperature in the ambient air, whereas the other is in the water in an aquarium.

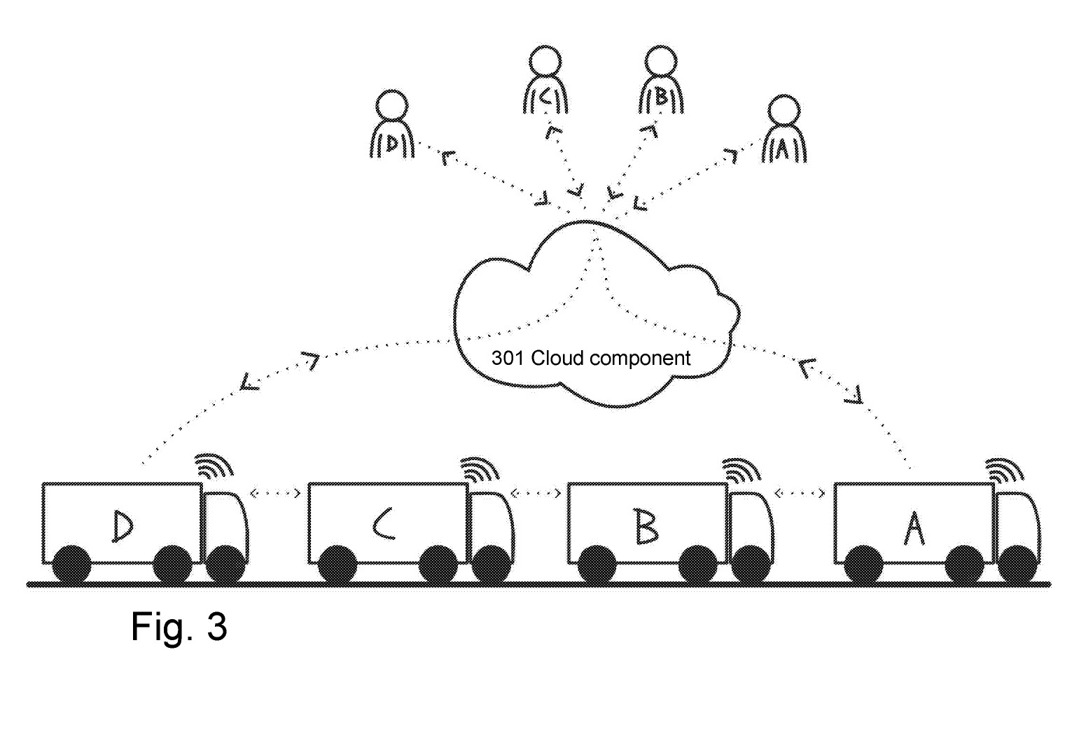

FIG. 3 shows an overview of an exemplifying truck platoon. Four remote drivers A, B, C and D are set up to control a respective truck, A, B, C and D via a cloud component 301. In this example, only vehicle A, and potentially vehicle D too, are in a fully active state. Sensor data from A, and potentially D, are shared to the remote drivers of B and C. If for example four remotely controlled trucks A, B, C and D are driving next after each other on a highway, truck A-D, and each of them include a number of sensors reporting to respectively remote driver, driver A-D, these should be able to form an ad-hoc network and share some of the equivalent sensors.

In more detail, vehicle A, B, C and D have, for example, sensors measuring the temperature of the road surface and the friction between the road surface and the tires, embedded in the tires. In this manner, the sensors may provide to the vehicle information about whether the road is slippery, e.g. due to ice, mud or the like. Vehicles in the vicinity of each other, that is A-D, form a MANET as they are driven in a line close to each other, a so called platoon of vehicles. Via M2M communication the equivalent sensors are detected, as they all carry a manifest or identification telling that they are temperature sensors and friction sensors respectively.

When it has been detected, e.g. by one of the vehicles in the ad-hoc network, that there are matching sensors, it has to be determined, by the cloud component, whether these sensors report similar values. The data from all the temperature sensors and friction sensors respectively are compared in the cloud component, which is aware of the thresholds for being considered as equivalent for this particular type of sensor. Here things like different materials of the tires might come in to play, and can result in differing values regarding the state of the road even though they all are measuring on the same road. But since what the friction sensor actually measures is the force between the road and tire, and if the friction coefficient etc. of each type of tire in which the sensor is located is known, by the cloud component, that can be taken into account to “equalize” the measures to be able consider them as equivalent.

If there are several matching sensors, let us say the temperature sensors in vehicle A, B, and D, then only one of these corresponding sensors has to remain active, and preferably the first one in the line of vehicles, i.e. in vehicle A. Temperature sensors in B and D can then enter the dormant state, enforced by the cloud component as in action 216-218, and sensor A reports its values to the vehicles as well as the remote derivers. As soon as the vehicles A, B, and D do not move uniformly any longer, sensors B and D are reactivated. This means that the first and second mobility information may be regularly, or irregularly, received and checked against the range for considering the first and second information about mobility to be equivalent. Even though the vehicles continue to move uniformly they may for any reason stop measuring equivalent values. Therefore the dormant sensors have to be regularly controlled, for example by taking a random sample from them every other minute or so. This is also controlled by the cloud component. If the values would not be within the interval any longer, all sensors are activated again. This means that the margin for using the first value as basis for the surrogate value to be sent to the second receiver device 121 may be checked regularly, or irregularly.

As explained above, some embodiments herein makes it possible for the trucks, or other connected object, to be aware of their surrounding and what sensors that are situated in the proximity thereof, and if these sensors are reporting equivalent values. Again, the first embodiments also enable the possibility to determine which one of the potential equivalent sensors that should be shared, and which that should enter the dormant state.

Furthermore, the embodiments enable that data streams from the active, now shared, sensors are redirected to the receiver device(s) of the data streams from the now dormant sensors.

So, if the trucks identify other trucks in back and front using M2M communication in the ad-hoc network, the sensors in these can start comparing themselves with each other, whereupon the cloud component evaluates whether there are any of them that are equivalent to allow it/them be shared. In this case the majority of the sensors in truck C and B, and maybe D, can be deactivated and replaced by sharing their equivalents in truck A, and maybe D. That is, truck B and C are no longer connected directly to their remote drivers, but all communication goes via truck A and/or D.

However, the likelihood of sensors reporting exactly the same values is in practice fairly low. For example, different trucks may not register the same outside temperature or when travelling in a platoon, as they all might have some measurement errors. Therefore a margin, or a tolerable interval, may be defined for each type of sensor in order for it to be considered as equivalent, i.e. not identical, but sufficiently similar enough. Within tolerable intervals values can differ depending on type of sensor, speed of travelling, measurement errors, and so forth, and still be equal enough to be valid as equivalent. Also, in some cases it may be possible to adjust values in the cloud component if, for example, there is only a constant, or function, that makes the values differ, like for example different units (e.g. seconds, minutes, miles, meters etc).

According to the embodiments herein, the cloud components may be closely integrated and distributed in the network. Hence, tasks demanding more processing can be performed in the networks, and on the machine-to-machine (M2M) communication level, e.g. in the ad-hoc network, it is just determined whether there are sensors of the same type, e.g. two temperature sensors.

In the ad-hoc, it can be determined if the sensors are of the same type if each sensor has an identification, e.g. a manifest or specification, stating what type of sensor it is, and hence fairly easily be communicated directly between the sensors in the local ad-hoc network. In order to compare the values and determine if two sensors of the same type report equivalent values, somewhat more computing and certain algorithms might be needed, hence that has to be decided in the cloud component. Moreover, it is in the cloud component where the thresholds, the margins etc. for different conditions and sensors are stored.

With reference to the third embodiments, in which sensors, or rather the sensor data, are shared to machines, taken as an example of the first and/or second receiver device, that benefit from access to the sensor data, but are not equipped with the particular type of sensor themselves. Since sensor data oftentimes is highly local and context dependent, the proximity may need to be taken into account when determining whether values shall be evaluated to check if they are equivalent.

An example with construction machines preparing the terrain prior to constructing a building, a road, a bridge or similar, will be described to illustrate this further. In this example, there are a variety of machines or vehicles in a confined area, such as the construction site. These machines have a common goal, which is to prepare the ground, dig, drain, adjust topology, put down pipes, and so on. Different machines will be equipped with different types of sensors, and the machines will be distributed within the area. All machines in the construction site can be connected to each other in an ad-hoc local network and together form a pool of sensors, which sensor data can be shared between the connected machines, and to their remote operators, the receiver device or the like. The machines can for example be excavators and loaders of various types. One excavator may have sensors with the capability to determine the composition of the soil or map the topology, with for example soil moisture sensors, infra read sensors, gyroscopic sensors, and so on. An adjacent machine that is supposed to dig might lack that ability but—especially if remotely controlled—highly benefit from having detailed information about the ground it is working, if there are any big stones or other objects under the surface, and so forth. Hence, the machine equipped with these sensors can share the data to the machine lacking corresponding sensors. This is done within the ad-hoc network at the site. However, the matching of sensors and with machines lacking sensor data takes place in the cloud component. In this example with remotely controlled machines, there can be a request sent to the remote operator, if he/she wishes access to the sensor data from any of the available sensors in the proximity, the ones earlier referred to as the pool of sensors. If so it is presented to the operator. Alternatively, the sensor sharing can be completely autonomous controlled by algorithms in the cloud component, so the operator does not have to make any decision.

The initially described example with the trucks and deactivation of redundant sensors in a local ad-hoc network does of course apply in this construction site context too.

In relation to the third embodiments, it is noted that sharing of sensor data, or sensor data streams, to devices which are not equipped with a particular type of sensor does not save any network capacity, such as bandwidth, per se. However, the first wireless device and the second device may be made less complex, e.g. not including a certain sensor. This leads to lower manufacturing costs for these devices. Moreover, as earlier mentioned more efficient, e.g. safe, accurate or the like, operation may be possible.

In a further exemplifying method according to the first embodiments, there may be multiple machines of the same type at the construction site mentioned above. Then, there will be identical sensors potentially reporting equivalent values, if the sensors monitor conditions external to the excavator mentioned above. The condition may be something in the ambient environment, for example sensors detecting what is underneath the ground, taking measurements of the soil, monitoring the weather conditions, and so on.

The following actions may be performed:

As an example of an action performed before action 201, the machines, and/or other sensor equipped devices, at the construction site all connect in a local ad-hoc network.

As an example of an action performed within the ad-hoc network, without involvement of the network node 130, at least one of the first wireless device and the second device identifies whether there are any sensors of the same type.

When there are sensors of the same type, as identified in the preceding action, the value from the sensors of the same type are compared, by the network node 130, to determine if they are equivalent or not. This is done in order to find out if there are any redundant sensors that can be deactivated. The network node 130 has previously stored the margin, the threshold etc. for what is tolerable as equivalent values.

Then, if there are sensors of the same type reporting values considered as equivalent, as which is evaluated in the network node 139, all but one of them can enter a dormant state.

Subsequently, in order to make sure it is still correct that the dormant sensor should be dormant, the value from the dormant, or deactivated, sensor is checked a regular, or irregular, basis to see if they still are equivalent.

With sensors only giving binary values (e.g. movement or no movement as for the motion sensor) it is easier as no thresholds for what is considered as equivalent has to be involved; either all sensors report yes or they report no.

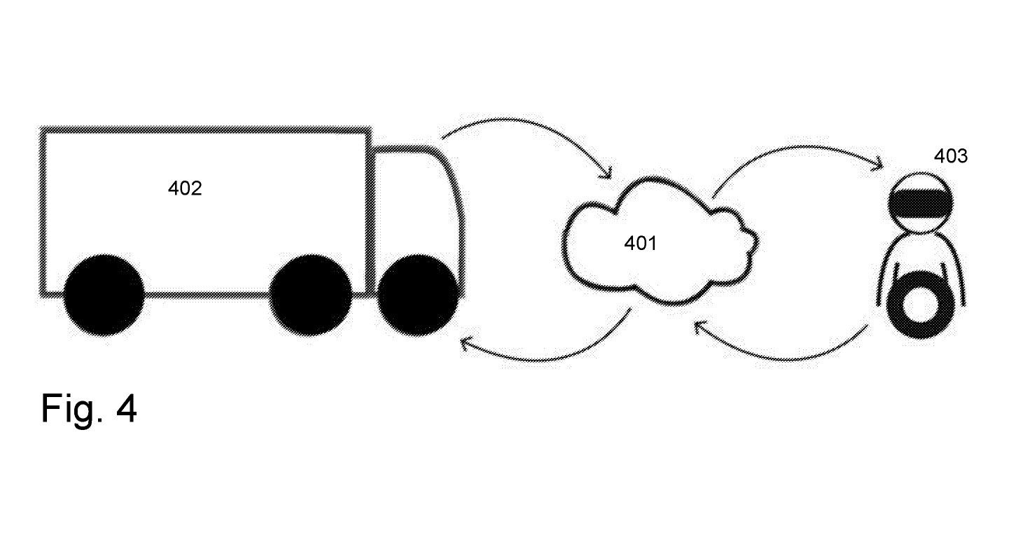

FIG. 4 illustrates an overview of an exemplifying system related to the embodiments herein. The system comprises a cloud component 401, as an example of the network node 130. A truck 402, as an example of the wireless device 110, is remotely controlled by a driver 403, as an example of the first and/or second receiver device 120, 121. The truck 402 may include one or more sensor modules (not shown). Additionally, it shall be understood that the driver 403 may be a real person or a computer that is set up to remotely control the truck 402.

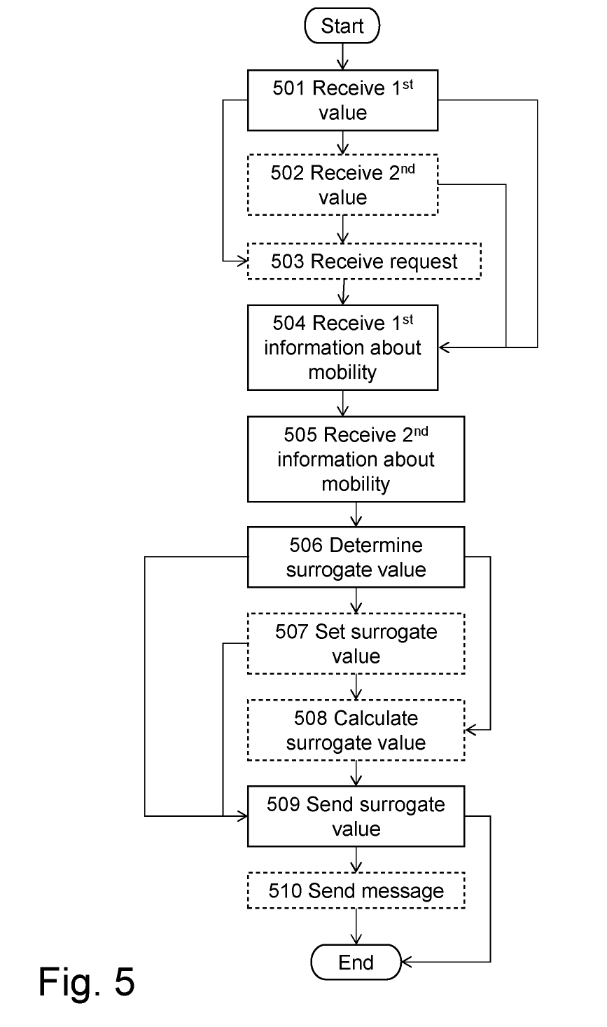

In FIG. 5, an exemplifying, schematic flowchart of the method in the network node 130 is shown. As mentioned, the network node 130 performs a method for managing a set of values of a physical quantity.

As mentioned, a communication network 100 comprises the network node 130, a first wireless device 110 and a second device 111. The first wireless device 110 is associated with a first sensor 115. The first sensor 115 is capable of detecting the physical quantity to obtain a first value for sending to a first receiver device 120. The first value is included in the set of values. The second device 111 is associated with a second receiver device 121.

The following actions may be performed in any suitable order.

### Action 501

The network node 130 receives, from the first wireless device 110, the first value of the physical quantity. The first value has been detected by the first sensor 115. This action is similar to action 202.

### Action 502

The network node 130 may receive, from the second device 111, a second value of the physical quantity. The second device 111 is associated with a second sensor 116 capable of detecting the physical quantity. The second value has been detected by the second sensor 116. This action is similar to action 204.

### Action 503

The network node 130 may receive, from the second receiver device 121, a request for a requested value, which relates to a requested physical quantity. The second device 111 is incapable of detecting the requested physical quantity to obtain the requested value. This action is similar to action 206.

### Action 504

The network node 130 receives first information about mobility from the first wireless device 110. This action is similar to action 208.

### Action 505

The network node 130 receives second information about mobility from the second device 111. This action is similar to action 210.

### Action 506

The network node 130 determines a surrogate value based on at least the first value, when the first information about mobility for the first wireless device 110 and the second information about mobility for the second device 111 are within a range for considering the first and second information about mobility to be equivalent. This action is similar to action 211.

### Action 507

The network node 130 may set the surrogate value to the first value with or without conversion from the first value to the second value, when the first and second values are within a margin for using the first value as basis for the surrogate value to be sent to the second receiver device 121.

Alternatively or additionally, the network node 130 may set the surrogate value to the first value with or without conversion from the first value to the requested value, when the physical quantity of the first value is equivalent to the requested physical quantity.

This action is similar to action 212.

### Action 508

The network node 130 may calculate the surrogate value as an average of the first and second values. This action is similar to action 213.

### Action 509

The network node 130 sends the surrogate value to the second receiver device 120. This action is similar to action 214.

### Action 510

The network node 130 may send, to the second device 111, a message instructing the second device 111 to cease to send the second value. This action is similar to action 216.

The network node 130 may now return to action 501 to repeatedly, e.g. at a regular or irregular time intervals, perform one or more of the actions described above. The network node 130 may wait before returning to action 501 or the network node 130 may immediately return to action 501.

With reference to FIG. 6, a schematic block diagram of the network node 130 is shown. The network node 130 is configured to manage a set of values of a physical quantity.

As mentioned, a communication network 100 comprises the network node 130, a first wireless device 110 and a second device 111. The first wireless device 110 is associated with a first sensor 115. The first sensor 115 is capable of detecting the physical quantity to obtain a first value for sending to a first receiver device 120. The first value is included in the set of values. The second device 111 is associated with a second receiver device 121.

The network node 130 may comprise a processing module 601, such as a means, one or more hardware modules and/or one or more software modules for performing the methods described herein.

The network node 130 may further comprise a memory 602. The memory may comprise, such as contain or store, a computer program 603.

According to some embodiments herein, the processing module 601 comprises, e.g. ‘is embodied in the form of’ or ‘realized by’, a processing circuit 604 as an exemplifying hardware module. In these embodiments, the memory 602 may comprise the computer program 603, comprising computer readable code units executable by the processing circuit 604, whereby the network node 130 is operative to perform the methods of FIG. 2 and/or FIG. 5.

In some other embodiments, the computer readable code units may cause the network node 130 to perform the method according to FIGS. 2 and/or 5 when the computer readable code units are executed by the network node 130.

FIG. 6 further illustrates a carrier 605, comprising the computer program 603 as described directly above. The carrier 605 may be one of an electronic signal, an optical signal, a radio signal, and a computer readable medium.

In some embodiments, the processing module 601 comprises an Input/Output (I/O) unit 606, which may be exemplified by a receiving module and/or a sending module as described below when applicable.

In further embodiments, the network node 130 and/or the processing module 601 may comprise one or more of a receiving module 610, a determining module 620, a sending module 630, a setting module 640 and a calculating module 650 as exemplifying hardware modules. In other examples, the aforementioned exemplifying hardware module may be implemented as one or more software modules.

Therefore, according to the various embodiments described above, the network node 130 is operative to and/or the network node 130, the processing module 601 and/or the receiving module 610 is configured to receive, from the first wireless device 110, the first value of the physical quantity. The first value has been detected by the first sensor 115.

The network node 130 is operative to and/or the network node, the processing module 601 and/or the receiving module 610 is further configured to receive first information about mobility from the first wireless device 110.

Moreover, the network node 130 is operative to and/or the network node 130, the processing module 601 and/or the receiving module 610 is configured to receive second information about mobility from the second device 111.

The network node 130 is operative to and/or the network node 130, the processing module 601 and/or the receiving module 610 may be configured to receive, from the second device 111, a second value of the physical quantity. The second device 111 may be associated with a second sensor 116 capable of detecting the physical quantity. The second value may have been detected by the second sensor 116.

The network node 130 is operative to and/or the network node 130, the processing module 601 and/or the receiving module 610 may be configured to receive, from the second receiver device 121, a request for a requested value, which relates to a requested physical quantity. The second device 111 is incapable of detecting the requested physical quantity to obtain the requested value.

Furthermore, the network node 130 is operative to and/or the network node 130, the processing module 601 and/or the determining module 620 is configured to determine a surrogate value based on at least the first value, when the first information about mobility for the first wireless device 110 and the second information about mobility for the second device 111 are within a range for considering the first and second information about mobility to be equivalent.

The network node 130 is operative to and/or the network node 130, the processing module 601 and/or the sending module 630 is configured to send the surrogate value to the second receiver device 120.

The network node 130 is operative to and/or the network node 130, the processing module 601 and/or the sending module 630 may be configured to send, to the second device 111, a message instructing the second device 111 to cease to send the second value.

The network node 130 is operative to and/or the network node 130, the processing module 601 and/or the setting module 640 may be configured to set the surrogate value to the first value with or without conversion from the first value to the second value, when the first and second values are within a margin for using the first value as basis for the surrogate value to be sent to the second receiver device 121.

The network node 130 is operative to and/or the network node 130, the processing module 601 and/or the setting module 640 may be configured to set the surrogate value to the first value with or without conversion from the first value to the requested value, when the physical quantity of the first value is equivalent to the requested physical quantity.

The network node 130 is operative to and/or the network node 130, the processing module 601 and/or the calculating module 650 may be configured to calculate the surrogate value as an average of the first and second values.

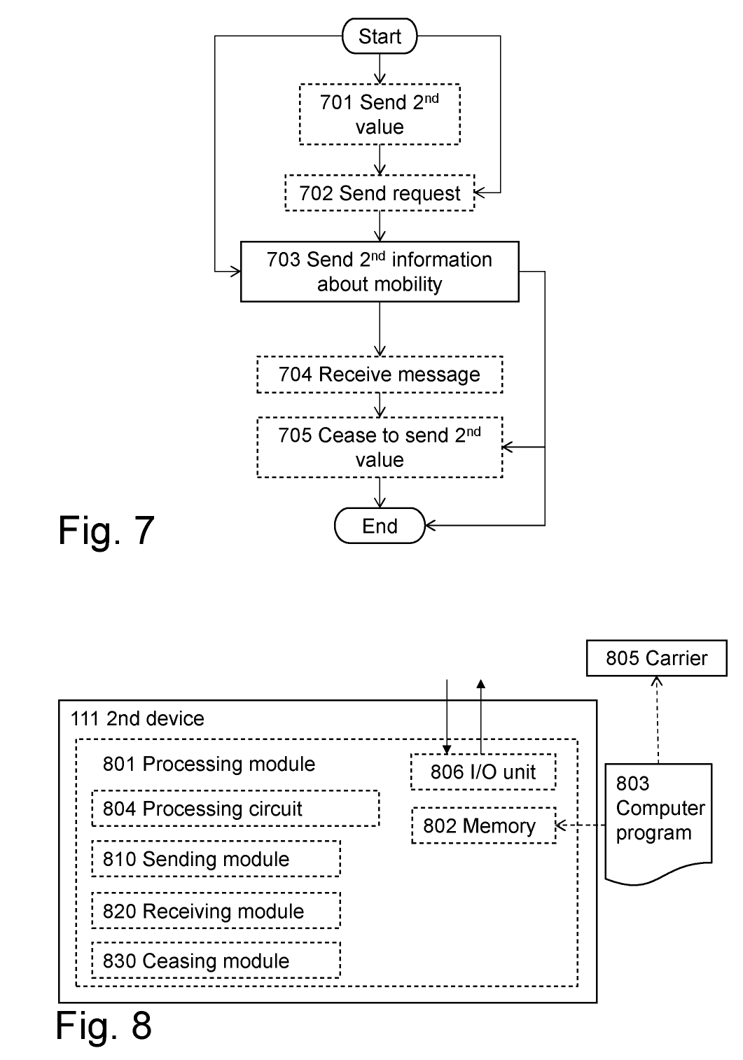

In FIG. 7, an exemplifying, schematic flowchart of the method in the second device 111 is shown. As mentioned, the second device 111 performs a method for managing sending of a second value of a physical quantity in order to reduce required bandwidth of a connection for sending of the second value to a network node 130 while maintaining accuracy of the second value above a threshold value.

As mentioned, the required bandwidth relates to bandwidth required for the sending of the second value. The second device 111 is associated with a second sensor 116. The second sensor 116 is capable of detecting the physical quantity to obtain the second value, wherein a first wireless device 110 and the second device 111 are comprised in an ad-hoc network 101. The ad-hoc network 101 and the network node 130 are comprised in a communication network 100. The first wireless device 110 is associated with a first sensor 115 capable of detecting the physical quantity to obtain a first value. The first and second devices 110, 111 are connected to the network node 130 in order to enable sharing of a set of values. The set of values includes the first and second values.

The following actions may be performed in any suitable order.

### Action 701

The second device 111 sends, over the connection to the network node 130, the second value relating to the physical quantity. The second value has been detected by the second sensor 116, whereby the network node 130 is able to determine whether a difference between the first and second values is below the threshold value. This action is similar to action 203.

### Action 702

The second device 111 may send a request. This action is similar to action 205.

### Action 703

The second device 111 may send second information about mobility. This action is similar to action 209.

### Action 704

The second device 111 may receive, from the network node 130, a message instructing the second device 111 to cease to perform the sending of the second value, when the network node 130 has determined that the difference is below the threshold value. This action is similar to action 217.

### Action 705

The second device 111 may cease to send the second value to the network node 130. This action is similar to action 218.

The second device 111 may now return to action 701 to repeatedly, e.g. at a regular or irregular time intervals, perform one or more of the actions described above. The second device 111 may wait before returning to action 701 or the second device 111 may immediately return to action 701.

With reference to FIG. 8, a schematic block diagram of the second device 111 is shown. The second device 111 is configured to manage sending of a second value of a physical quantity in order to reduce required bandwidth of a connection for sending of the second value to a network node 130 while maintaining accuracy of the second value above a threshold value.

As mentioned, the required bandwidth relates to bandwidth required for the sending of the second value. The second device 111 is associated with a second sensor 116. The second sensor 116 is capable of detecting the physical quantity to obtain the second value, wherein a first wireless device 110 and the second device 111 are comprised in an ad-hoc network 101. The ad-hoc network 101 and the network node 130 are comprised in a communication network 100. The first wireless device 110 is associated with a first sensor 115 capable of detecting the physical quantity to obtain a first value. The first and second devices 110, 111 are connected to the network node 130 in order to enable sharing of a set of values. The set of values includes the first and second values.

The second device 111 may comprise a processing module 801, such as a means, one or more hardware modules and/or one or more software modules for performing the methods described herein.

The second device 111 may further comprise a memory 802. The memory may comprise, such as contain or store, a computer program 803.

According to some embodiments herein, the processing module 801 comprises, e.g. ‘is embodied in the form of’ or ‘realized by’, a processing circuit 804 as an exemplifying hardware module. In these embodiments, the memory 802 may comprise the computer program 803, comprising computer readable code units executable by the processing circuit 804, whereby the second device 111 is operative to perform the methods of FIG. 2 and/or FIG. 7.

In some other embodiments, the computer readable code units may cause the second device 111 to perform the method according to FIG. 2 and/or FIG. 7 when the computer readable code units are executed by the second device 111.

FIG. 8 further illustrates a carrier 805, comprising the computer program 803 as described directly above. The carrier 805 may be one of an electronic signal, an optical signal, a radio signal, and a computer readable medium.

In some embodiments, the processing module 801 comprises an Input/Output (I/O) unit 806, which may be exemplified by a receiving module and/or a sending module as described below when applicable.

In further embodiments, the second device 111 and/or the processing module 801 may comprise one or more of a sending module 810, a receiving module 820 and a ceasing module 830 as exemplifying hardware modules. In other examples, the aforementioned exemplifying hardware module may be implemented as one or more software modules.

Therefore, according to the various embodiments described above, the second device 111 is operative to and/or the second device 111, the processing module 801 and/or the sending module 810 is configured to send, over the connection to the network node 130, the second value relating to the physical quantity. The second value has been detected by the second sensor 116, whereby the network node 130 is able to determine whether a difference between the first and second values is below the threshold value.

The second device 111 is operative to and/or the second device 111, the processing module 801 and/or the receiving module 820 is configured to receive, from the network node 130, a message instructing the second device 111 to cease to perform the sending of the second value, when the network node 130 has determined that the difference is below the threshold value.

Furthermore, the second device 111 is operative to and/or the second device 111, the processing module 801 and/or the ceasing module 830 is configured to cease to send the second value to the network node 130.

As used herein, the term “processing module” may in some examples refer to a processing circuit, a processing unit, a processor, an Application Specific integrated Circuit (ASIC), a Field-Programmable Gate Array (FPGA) or the like. As an example, a processor, an ASIC, an FPGA or the like may comprise one or more processor kernels. In these examples, the processing module is thus embodiment by a hardware module. In other examples, the processing module may be embodied by a software module. Any such module, be it a hardware, software or combined hardware-software module, may be a determining means, estimating means, capturing means, associating means, comparing means, identification means, selecting means, receiving means, sending means or the like as disclosed herein. As an example, the expression “means” may be a module or a unit, such as a determining module and the like correspondingly to the above listed means.

As used herein, the expression “configured to” may mean that a processing circuit is configured to, or adapted to, by means of software configuration and/or hardware configuration, perform one or more of the actions described herein.

As used herein, the term “memory” may refer to a hard disk, a magnetic storage medium, a portable computer diskette or disc, flash memory, random access memory (RAM) or the like. Furthermore, the term “memory” may refer to an internal register memory of a processor or the like.

As used herein, the term “computer readable medium” may be a Universal Serial Bus (USB) memory, a DVD-disc, a Blu-ray disc, a software module that is received as a stream of data, a Flash memory, a hard drive, a memory card, such as a MemoryStick, a Multimedia Card (MMC), etc.

As used herein, the term “computer readable code units” may be text of a computer program, parts of or an entire binary file representing a computer program in a compiled format or anything there between.

As used herein, the terms “number”, “value” may be any kind of digit, such as binary, real, imaginary or rational number or the like. Moreover, “number”, “value” may be one or more characters, such as a letter or a string of letters. “number”, “value” may also be represented by a bit string.

As used herein, the expression “in some embodiments” has been used to indicate that the features of the embodiment described may be combined with any other embodiment disclosed herein.

Even though embodiments of the various aspects have been described, many different alterations, modifications and the like thereof will become apparent for those skilled in the art. The described embodiments are therefore not intended to limit the scope of the present disclosure.

1. A method, performed by a network node, for managing a set of values of a physical quantity, wherein a communication network comprises the network node, a first wireless device and a second device, wherein the first wireless device is associated with a first sensor, wherein the first sensor is capable of detecting the physical quantity to obtain a first value for sending to a first receiver device, wherein the first value is included in the set of values, wherein the second device is associated with a second receiver device, wherein the method comprises:
receiving from the first wireless device, the first value of the physical quantity, wherein the first value has been detected by the first sensor;
receiving first information about mobility from the first wireless device;
receiving second information about mobility from the second device;
responsive to determining that the first information about mobility for the first wireless device and the second information about mobility for the second device are within a range for considering the first and second information about mobility to be equivalent,
determining a surrogate value based on at least the first value, and sending the surrogate value to the second receiver device.

2. The method according to claim 1, wherein the method further comprises:
receiving, from the second device, a second value of the physical quantity, wherein the second device is associated with a second sensor capable of detecting the physical quantity, wherein the second value has been detected by the second sensor.

3. The method according to claim 2, wherein the method comprises:
setting the surrogate value to the first value with or without conversion from the first value to the second value, when the first and second values are within a margin for using the first value as basis for the surrogate value to be sent to the second receiver device; and
sending, to the second device, a message instructing the second device to cease to send the second value.

4. The method according to claim 2, wherein method comprises:
calculating the surrogate value as an average of the first and second values.

5. The method according to claim 1, wherein the method further comprises:
receiving, from the second receiver device, a request for a requested value, which relates to a requested physical quantity, wherein the second device is incapable of detecting the requested physical quantity to obtain the requested value; and
setting the surrogate value to the first value with or without conversion from the first value to the requested value, when the physical quantity of the first value is equivalent to the requested physical quantity.

6. A method, performed by a second device, for managing sending of a second value of a physical quantity in order to reduce required bandwidth of a connection for sending of the second value to a network node while maintaining accuracy of the second value above a threshold value, wherein the required bandwidth relates to bandwidth required for the sending of the second value, wherein the second device is associated with a second sensor, wherein the second sensor is capable of detecting the physical quantity to obtain the second value, wherein a first wireless device and the second device are comprised in an ad-hoc network, wherein the ad-hoc network and the network node are comprised in a communication network, wherein the first wireless device is associated with a first sensor capable of detecting the physical quantity to obtain a first value, wherein the first and second devices are connected to the network node in order to enable sharing of a set of values, wherein the set of values includes the first and second values, wherein the method comprises:
sending over the connection to the network node, the second value relating to the physical quantity, wherein the second value has been detected by the second sensor, whereby the network node is able to determine whether a difference between the first and second values is below the threshold value;
receiving, from the network node, a message instructing the second device to cease to perform the sending of the second value, when the network node has determined that the difference is below the threshold value; and
ceasing to send the second value to the network node.

7. A network node configured to manage a set of values of a physical quantity, wherein a communication network comprises the network node, a first wireless device and a second device, wherein the first wireless device is associated with a first sensor, wherein the first sensor is capable of detecting the physical quantity to obtain a first value for sending to a first receiver device, wherein the first value is included in the set of values, wherein the second device is associated with a second receiver device, wherein the network node is configured to:
receive, from the first wireless device, the first value of the physical quantity, wherein the first value has been detected by the first sensor;
receive first information about mobility from the first wireless device;
receive second information about mobility from the second device;
responsive to determining that the first information about mobility for the first wireless device and the second information about mobility for the second device are within a range for considering the first and second information about mobility to be equivalent,
determine a surrogate value based on at least the first value, and
send the surrogate value to the second receiver device.

8. The network node according to claim 7, wherein the network node is configured to:
receive, from the second device, a second value of the physical quantity, wherein the second device is associated with a second sensor capable of detecting the physical quantity, wherein the second value has been detected by the second sensor.

9. The network node according to claim 8, wherein the network node is configured to:
set the surrogate value to the first value with or without conversion from the first value to the second value, when the first and second values are within a margin for using the first value as basis for the surrogate value to be sent to the second receiver device; and
send, to the second device, a message instructing the second device to cease to send the second value.

10. The network node according to claim 8, wherein network node is configured to:
calculate the surrogate value as an average of the first and second values.

11. The network node according to claim 7, wherein the network node is configured to:
receive, from the second receiver device, a request for a requested value, which relates to a requested physical quantity, wherein the second device is incapable of detecting the requested physical quantity to obtain the requested value; and
set the surrogate value to the first value with or without conversion from the first value to the requested value, when the physical quantity of the first value is equivalent to the requested physical quantity.

12. A second device configured to manage sending of a second value of a physical quantity in order to reduce required bandwidth of a connection for sending of the second value to a network node while maintaining accuracy of the second value above a threshold value, wherein the required bandwidth relates to bandwidth required for the sending of the second value, wherein the second device is associated with a second sensor, wherein the second sensor is capable of detecting the physical quantity to obtain the second value, wherein a first wireless device and the second device are comprised in an ad-hoc network, wherein the ad-hoc network and the network node are comprised in a communication network, wherein the first wireless device is associated with a first sensor capable of detecting the physical quantity to obtain a first value, wherein the first and second devices are connected to the network node in order to enable sharing of a set of values, wherein the set of values includes the first and second values, wherein the second device is configured to:
send, over the connection to the network node, the second value relating to the physical quantity, wherein the second value has been detected by the second sensor, whereby the network node is able to determine whether a difference between the first and second values is below the threshold value;
receive, from the network node, a message instructing the second device to cease to perform the sending of the second value, when the network node has determined that the difference is below the threshold value; and
cease to send the second value to the network node.

13. A computer program product comprising a non-transitory computer readable storage medium storing program code which when executed on a processor of a network node causes the network node to perform the method according to claim 1.

14. (canceled)

15. A computer program product comprising a non-transitory computer readable storage medium storing program code units which when executed on a processor of a second device causes the second device to perform the method according to claim 6.

16. (canceled)
